(19) United States
(12) Patent Application Publication
(10) Pub. No.: US 2023/0411786 A1
(43) Pub. Date: Dec. 21, 2023

(54) POROUS ARAMID NANOFIBER THIN FILM, METHOD FOR MANUFACTURING SAME, AND SECONDARY BATTERY COMPRISING SAME

(71) Applicants: IUCF-HYU (INDUSTRY-UNIVERSITY COOPERATION FOUNDATION HANYANG UNIVERSITY), Seoul (KR); KOREA INSTITUTE OF SCIENCE AND TECHNOLOGY, Seoul (KR)

(72) Inventors: Bong Jun YEOM, Seoul (KR); Jeong Gon SON, Seoul (KR); A Rum JUNG, Hwaseong-si Gyeonggi-do (KR); Na Yeon KIM, Namyangju-si Gyeonggi-do (KR)

(73) Assignees: IUCF-HYU (INDUSTRY-UNIVERSITY COOPERATION FOUNDATION HANYANG UNIVERSITY), Seoul (KR); KOREA INSTITUTE OF SCIENCE AND TECHNOLOGY, Seoul (KR)

(21) Appl. No.: 18/036,287

(22) PCT Filed: Nov. 8, 2021
(86) PCT No.: PCT/KR2021/016090

§ 371 Date: May 10, 2023

(30) Foreign Application Priority Data
Nov. 11, 2020 (KR) 10-2020-0150357

(51) Int. Cl. H01M 50/423; H01M 50/403; H01M 50/491; H01M 10/052; H01M 4/38

(52) U.S. Cl. CPC H01M 50/423; H01M 50/403; H01M 50/491; H01M 10/052; H01M 4/382; H01M 2004/027

(57) ABSTRACT

A porous aramid nanofiber film, a manufacturing method thereof, and a secondary battery including the same are provided. The method of manufacturing the porous aramid nanofiber film includes forming an aramid nanoseed suspension layer by applying an aramid nanoseed suspension on a substrate. The suspension layer is immersed in an alcohol-containing protic solvent for first solvent exchange to prepare an aramid nanofiber film by self-assembly. The aramid nanofiber film is immersed in water for second solvent exchange to form an aramid nanofiber hydrogel film. Freeze-drying the aramid nanofiber hydrogel film to prepare a porous aramid nanofiber film.

### TECHNICAL FIELD

The present invention relates to a separator for secondary battery, and more particularly, to a porous aramid nanofiber separator.

### BACKGROUND ART

A secondary battery is a chemical battery that can be used semi-permanently by continuously repeating charging and discharging using an electrochemical reaction, and is classified into a lead acid battery, a nickel-cadmium battery, a nickel-hydrogen battery, and a lithium secondary battery. Among them, the lithium secondary battery is leading the secondary battery market because it has excellent high voltage and energy density characteristics compared to other batteries.

Lithium secondary batteries are characterized by having high energy density and high output, and have been used in portable devices such as mobile phones and laptop computers. In addition, interest in electric vehicles (EVs) has recently increased due to environmental issues, and compared to nickel-metal hydride batteries, there is no memory effect, and the lithium secondary battery are convenient to use and can be miniaturized due to high energy and high output characteristics; therefore, research on the lithium secondary battery for electric vehicles is actively progressing. In addition, the need for a next-generation lithium battery having high specific capacity and stable electrochemical characteristics even during high-speed charging and discharging is gradually increasing. As lithium metal has theoretically very high specific capacity (3860 mAh/g), low density (0.59 g/cm³), and very low electrochemical potential (−3.04 V vs. the standard hydrogen electrode), it is in the limelight as a negative electrode material for next-generation high-capacity batteries such as lithium-sulfur batteries and lithium-air batteries. It has a specific capacity more than 10 times that of the Li/C negative electrode currently used as a negative electrode, and has the advantage of reducing the weight of the entire cell.

The lithium secondary battery includes a positive electrode, a negative electrode, an electrolyte, and a separator. Among them, the required characteristic of the lithium secondary battery separator is to separate and electrically insulate the positive and negative electrodes while increasing the ionic conductivity of lithium ions based on high porosity. Polyolefin (PO), which is advantageous in forming pores and has excellent chemical resistance, mechanical properties, and thermal properties, is mainly used as a polymer substrate of a commonly used separator. However, when a conventional polyolefin-based separator is used in a secondary battery using a metal such as lithium as a negative electrode, dendrites are formed on the surface of the metal such as lithium due to repeated charging and discharging. As such, problems such as battery performance deterioration such as low coulombic efficiency and ignition due to short circuit between electrodes have not yet been solved.

### DISCLOSURE

### Technical Problem

Since the above problems are difficult to solve with a single solution, various methods have been proposed, such as materials and structures of electrodes, electrolytes, and interfaces. Among them, it is necessary to develop a new separator that can replace the existing olefin-based separator. This new separator is expected to have stable electrochemical properties, high thermal stability, low resistivity and high ionic conductivity, and suppress the formation of lithium dendrites generated in the solid-electrolyte-interface layer of the negative electrode, thereby increasing the lifespan and safety of the battery.

The problem to be solved by the present invention is to provide a method for manufacturing a porous aramid nanofiber film.

In addition, another problem to be solved by the present invention is to provide a porous aramid nanofiber film prepared by the above manufacturing method.

Furthermore, another problem to be solved by the present invention is to provide a secondary battery including the porous aramid nanofiber film as a separator.

The technical problems of the present invention are not limited to the technical problems mentioned above, and other technical problems not mentioned will be clearly understood by those skilled in the art from the following description.

### Technical Solution

One aspect of the present invention provides a method for producing a porous aramid nanofiber film. First, an aramid nanoseed suspension layer is formed by applying an aramid nanoseed suspension on a substrate. The suspension layer is immersed in an alcohol-containing protic solvent for first solvent exchange to prepare an aramid nanofiber film by self-assembly. The aramid nanofiber film is immersed in water for second solvent exchange to form an aramid nanofiber hydrogel film. Freeze-drying the aramid nanofiber hydrogel film to prepare a porous aramid nanofiber film.

The aramid nanoseed suspension may be prepared by putting aramid fibers in an organic solvent containing a base and stirring them. The organic solvent may be dimethyl sulfoxide, N-methyl-2-pyrrolidone, dimethylformamide, dimethyl sulfide, dimethylacetamide, or a mixture thereof. The base may be KOH. The aramid fibers may be contained in an amount of 1 to 20 parts by weight based on 100 parts by weight of the organic solvent.

A method for applying the aramid nanoseed suspension on the substrate may be selected from the group consisting of spin coating, blade coating, bar coating, dip coating, gravure coating, spray coating, roll coating and die coating.

The alcohol-containing protic solvent may be a solvent containing only alcohol or a mixed solvent of alcohol and water. The alcohol may have a lower boiling or freezing point than water. The alcohol may be ethanol.

One aspect of the present invention provides a porous aramid nanofiber film. The aramid nanofiber film may include micropores having an average pore diameter of 30 μm or less and nanopores having an average pore diameter of 100 nm or less. The film may have a porosity of 80 to 99%.

One aspect of the present invention provides a secondary battery. The secondary battery includes a positive electrode, a negative electrode, and a porous aramid nanofiber film interposed between the positive electrode and the negative electrode. The porous aramid nanofiber film includes micropores having an average pore diameter of 30 μm or less and nanopores having an average pore diameter of 100 nm or less. The negative electrode may be a lithium metal electrode, a sodium metal electrode, or a magnesium metal electrode. The secondary battery may be a lithium secondary battery.

### Advantageous Effects

According to the present invention, when preparing an aramid nanofiber hydrogel, a first solvent exchange step of immersing the aramid nanoseed suspension film in an alcohol-containing protic solvent and then a second solvent exchange step of immersing it in water are performed. Accordingly, a pore structure in which nano-micro sizes are mixed is formed in the aramid nanofiber film. Therefore, the aramid nanofiber film prepared by the manufacturing method according to the present invention has stable electrical properties, high thermal stability, low resistance and high ionic conductivity due to the nano-micro sized pore structure, so that the formation of lithium dendrites generated in the solid-electrolyte-interfacial layer can be suppressed. As a result, it can be usefully used as a secondary battery separator that improves battery life and safety.

However, the effects of the present invention are not limited to the above-mentioned effects, and other effects not mentioned will be clearly understood by those skilled in the art from the following description.

### DESCRIPTION OF DRAWINGS

FIG. 1 is a flow chart showing a method for manufacturing a porous aramid nanofiber film according to an embodiment of the present invention.

FIG. 2 is a schematic diagram showing a method for manufacturing a porous aramid nanofiber film according to an embodiment of the present invention.

FIG. 3 shows a field emission scanning electron microscope (FE-SEM) images taken at (a) low magnification and (b) high magnification of a commercially available polypropylene (Celgard 3501) separator according to Comparative Example 3.

FIG. 4 shows FE-SEM images taken at (a) low magnification and (b) high magnification of the porous aramid nanofiber film prepared according to Preparation Example 1 of the present invention.

FIG. 5 shows FE-SEM images of cross-sections of the porous aramid nanofiber film prepared according to Preparation Example 1 of the present invention (a) before applying pressure and (b) after applying pressure.

FIG. 6 shows (a) surface photographs, (b) optical microscope (OM) images, (c) surface FE-SEM images, and (d) cross-sectional FE-SEM images of aramid nanofiber films according to Preparation Example 1, Preparation Example 4, and Comparative Example 1 with different solvent exchange methods.

FIG. 7 shows (a) surface photographs, (b), (c), and (d) cross-sectional FE-SEM images of aramid nanofiber films according to Preparation Example 3, Preparation Example 5, and Comparative Example 2 with different solvent exchange methods.

FIG. 8 is a graph showing N₂ adsorption-desorption isotherms of an aramid nanofiber film prepared according to Preparation Example 1 and a polypropylene film (Celgard 3501) according to Comparative Example 3.

FIG. 9 is a graph showing the distribution of the pore size of the aramid nanofiber film prepared according to Preparation Example 1 and the polypropylene film (Celgard 3501) according to Comparative Example 3.

FIG. 10 is a graph showing the results of thermogravimetric analysis of separators according to Preparation Example 1 and Comparative Example 3.

FIG. 11 shows photographs indicating the degree of thermal contraction of the separators according to Preparation Example 1 and Comparative Example 3 during heat treatment at different temperatures.

FIG. 12 is a photograph showing the results of the electrolyte wettability test of the separators according to Preparation Example 1 and Comparative Example 3.

FIG. 13 is a graph showing the electrolyte wettability over time of separators according to Preparation Example 1 and Comparative Example 3.

FIG. 14 is a graph showing the impedance (interface resistance) of the separator according to Preparation Example 1 and Comparative Example 3, and the inset shows the bulk resistance.

FIG. 15(a) is a graph showing the constant current cycling test results for 800 cycles for the Li/Li symmetric cell according to Preparation Example 6 including the porous aramid nanofiber film (PANF) prepared in Preparation Example 1 and the Li/Li symmetric cell according to Comparative Example 6 including a polypropylene film (Celgard 3501) of Comparative Example 3, FIG. 15(b) is an enlarged view of the 25-50 cycle section of FIG. 15(a), and FIG. 15(c) is an enlarged view of the 0-5 cycle section of FIG. 15(a).

FIG. 16 shows graphs indicating the constant current cycling test results for the Li/Li symmetric cell according to Preparation Example 6 including the PANF prepared in Preparation Example 1 and the Li/Li symmetric cell according to Comparative Example 6 including a polypropylene film (Celgard 3501) of Comparative Example 3 at a current density of 5 mA/cm² and a cycle capacity of 1 mAh/cm².

FIG. 17 shows graphs indicating the constant current cycling test results at a current density of 10 mA/cm² and a cycle capacity of 1 mAh/cm².

FIG. 18 shows graphs indicating the constant current cycling test results for the Li/Li symmetric cell according to Preparation Example 6 including the PANF prepared in Preparation Example 1 and the Li/Li symmetric cell according to Comparative Example 6 including a polypropylene film (Celgard 3501) of Comparative Example 3 at a current density of 20 mA/cm² and a cycle capacity of 1 mAh/cm² (a, b) and at a current density of 100 mA/cm² and a cycle capacity of 1 mAh/cm² (c, d).

FIG. 19 shows graphs indicating the constant current cycling test results for the Li/Li symmetric cell according to Preparation Example 6 including the PANF prepared in Preparation Example 1 and the Li/Li symmetric cell according to Comparative Example 6 including a polypropylene film (Celgard 3501) of Comparative Example 3 at a current density of 20 mA/cm² and a cycle capacity of 20 mAh/cm² (a, b) and at a current density of 100 mA/cm² and a cycle capacity of 100 mAh/cm² (c, d).

FIG. 20 shows photographs (a) and FE-SEM images (b, c, d) showing the surfaces of Li electrodes after a cycling test of Li/Li symmetric cells according to Preparation Example 6 and Comparative Example 6 including separators according to Preparation Example 1 and Comparative Example 3, respectively.

FIG. 21 shows cycle test results at 1 C, 5 C, 10 C, 20 C, and 30 C (a), charge and discharge curves at 1 C, 10 C, and 30 C (b), and cycle performance and coulombic efficiency at 1 C, 10 C, and 30 C (c) of lithium secondary batteries according to Preparation Example 11 and Comparative Example 7.

### MODES OF THE INVENTION

Hereinafter, embodiments of the present invention will be described in detail with reference to the accompanying drawings. In describing the present invention, if it is determined that a detailed description of a related known function or configuration may unnecessarily obscure the subject matter of the present invention, the detailed description will be omitted. In addition, the terms used in this specification are terms used to appropriately express preferred embodiments of the present invention, which may vary according to a user's intention or customs in the field to which the present invention belongs. Therefore, definitions of these terms will have to be made based on the content throughout this specification.

Like reference numerals in each figure indicate like elements.

Throughout the specification, when a member is said to be located “on” another member, this includes not only a case where a member is in contact with another member, but also a case where still another member exists between the two members.

Throughout the specification, when a part “includes” a certain component, it means that it may further include other components without excluding other components unless otherwise stated.

Unless defined otherwise, all terms used herein, including technical or scientific terms, have the same meaning as commonly understood by one of ordinary skill in the art to which the present invention belongs. Terms such as those defined in commonly used dictionaries should be interpreted as having a meaning consistent with the meaning in the context of the related art, and unless explicitly defined in the present application, it should not be interpreted in an ideal or excessively formal meaning.

Manufacturing Method of Porous Aramid Nanofiber Film

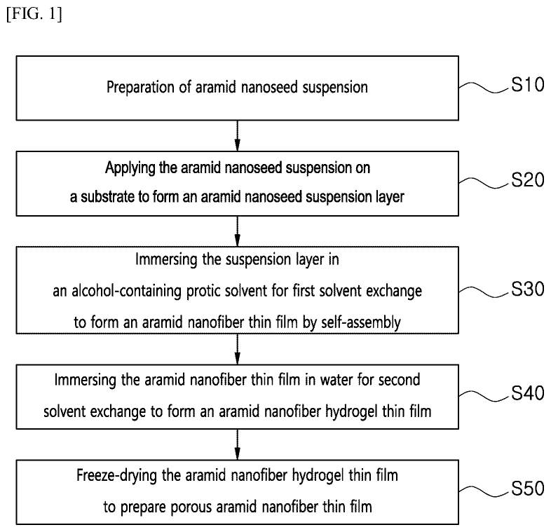

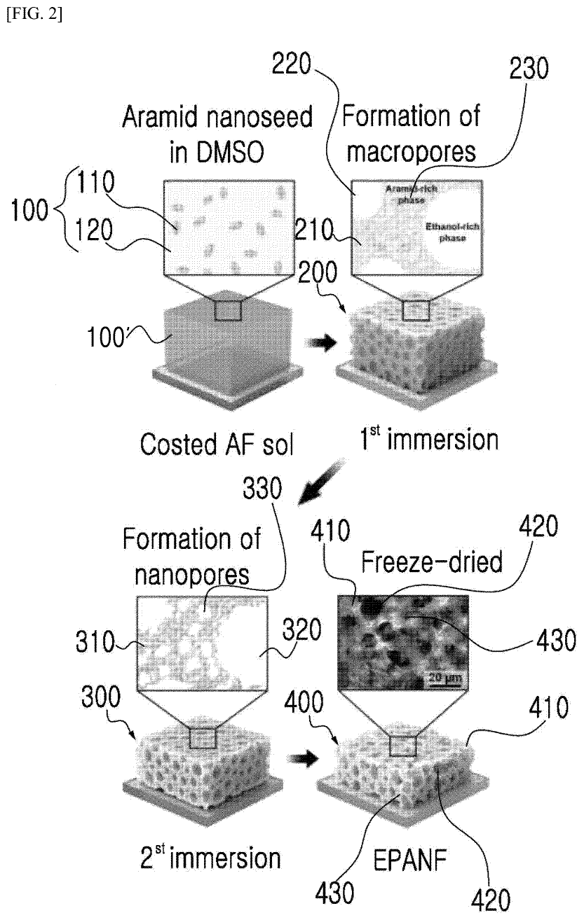

FIG. 1 is a flow chart showing a method for manufacturing a porous aramid nanofiber film according to an embodiment of the present invention. FIG. 2 is a schematic diagram showing a method for manufacturing a porous aramid nanofiber film according to an embodiment of the present invention.

Referring to FIGS. 1 and 2, an aramid nanoseed suspension 100 may be prepared (S10). The aramid nanoseed suspension 100 may be obtained by stirring aramid fibers in an organic solvent 120 containing a base, and the aramid fibers may be split in the solvent to obtain nanoseeds or nanofiber precursors 110, and the nanoseeds or the nanofiber precursor 110 may be suspended in the solvent 120. The suspension 100 may be in a sol state.

The aramid fiber refers to a high-tech fiber having a strength of at least 5 times to 10 times higher than that of a general fiber. The strength of a typical polyester fiber is 3 to 4 g/d, whereas the strength of aramid fiber is 20 to 27 g/d. The aramid fiber, also called aromatic polyamide, may have a decomposition temperature of 400° C., may be a high-performance heat-resistant material that can be continuously used at 160° C. or higher, and the polymer itself has excellent heat resistance.

The aramid fibers may have a weight average molecular weight of 1,000,000 to 5,000,000 g/mol, specifically 1,500,000 to 4,000,000 g/mol, and more specifically 2,000,000 to 4,000,000 g/mol.

In addition, the aramid used in the present invention may be a linear polymer in which 60% or more of the bonds linking benzene rings or naphthalene rings are amide bonds, and may include a high molecular weight wholly aromatic polyamide. In the case of aramid having the benzene rings, it is largely classified into meta-aramid and para-aramid according to the substitution position of the amide bond. That is, it is divided into para-aramid fibers having a structure in which benzene rings are linearly connected through an amide group (CONH) and meta-aramid fibers that are not. Examples of the meta-aramid may include polymetaphenylene isophthalamide and copolymers thereof, and examples of the para-aramid may include polyparaphenylene terephthalamide and copolymers thereof, poly(paraphenylene)-copoly(3,4-diphenylene ether) terephthalamide, and the like. However, it is not limited to this.

The method for producing aramid is not particularly limited, but generally includes a two-step interfacial polymerization method, a solution polymerization method by a condensation reaction of an aromatic diamine with an aromatic dicarboxylic acid or a dihalide compound of an aromatic dicarboxylic acid, and the like. The aramid can be industrially produced by these methods. In addition, other components may be copolymerized within the aramid within a range that does not impair the properties of the aramid.

Aramid fibers added to and dissolved within the organic solvent may have a ratio of 1 to 20 parts by weight based on 100 parts by weight of the solvent. Specifically, the aramid fibers may have a ratio of 3 to 17 parts by weight, more specifically 5 to 15 parts by weight, based on 100 parts by weight of the solvent. It can exhibit a viscosity suitable for application within the above range. If the content of aramid fibers is less than 5 parts by weight, the viscosity of the suspension becomes weak, and the strength and physical properties of the prepared porous film tend to decrease, and if the content of aramid fibers is more than 20 parts by weight, the viscosity becomes strong, making film formation difficult, and the thickness of the produced film may increase and the average pore size may decrease.

In addition, the aramid fiber may be an aramid microfiber having a micrometer diameter, and the diameter may be 1 to 100 μm, specifically 5 to 20 μm, and more specifically, 10 to 15 μm. In these aramid fibers, a plurality of polymer backbones may be bonded by hydrogen bonds between amide groups in the backbones to constitute nanofibers with a diameter of nanometers, and these nanofibers may be bonded by hydrogen bonds between amide groups in the nanofibers to constitute microfibers of micrometer size.

The organic solvent may be, for example, an aprotic solvent such as dimethyl sulfoxide, N-methyl-2-pyrrolidone, dimethylformamide, dimethyl sulfide, dimethylacetamide, or a mixture thereof. The base may be an alkali metal hydroxide, for example, a strong base such as KOH or NaOH. The base may be contained in an amount of 1 to 2 parts by weight based on 100 parts by weight of the aprotic solvent.

Amide groups of some polymer backbones included in the aramid fibers, that is, aramid microfibers, may be deprotonated by the strong base to generate nitrogen anions (—CON⁻—). As a result, the aramid microfibers can be split in the solvent due to the strong electrostatic repulsive force between the nitrogen anions (—CON⁻—). In this process, amide groups of all polymer backbones cannot be deprotonated, and hydrogen bonds between amide groups of some polymer backbones can be maintained. In this way, in the aramid microfiber, some polymer backbones are split by electrostatic repulsion due to deprotonation of some amide groups, and at the same time, other polymer backbones remain aggregated by hydrogen bonding, thereby forming the nanoseed 110.

The nanoseeds 110 may be suspended in the solvent 120 to be in a sol state, and when sufficiently suspended, the nanoseeds 110 may not be visually recognized. Agitation may be used as above to facilitate the suspension.

Thereafter, the aramid nanoseed suspension 100 may be applied on the substrate to form an aramid nanoseed suspension layer 100′ (S20).

The substrate may be a glass, metal, semiconductor, or polymer substrate. The semiconductor substrate may be a silicon substrate, the metal substrate may be stainless steel, aluminum, or copper alloy, and the polymer substrate may be a PET substrate. As an application method, for example, various methods such as spin coating, blade coating, bar coating, dip coating, gravure coating, spray coating, roll coating, and die coating may be used. The aramid nanoseed suspension layer 100′ immediately after application may have a thickness of several tens to hundreds of micrometers, for example, 30 to 200 μm.

The aramid nanoseed suspension layer 100′ may be immersed in an alcohol-containing protic solvent to perform first solvent exchange to form an aramid nanofiber film or aramid nanofiber alcohol gel film 200 by self-assembly (S30).

The alcohol-containing protic solvent may be a solvent containing only alcohol or a mixed solvent of alcohol and water. Here, the alcohol has a lower boiling point or freezing point than water, and may be, for example, methanol, ethanol, n-propanol, isopropyl alcohol, or a mixture thereof. Specifically, the alcohol may be ethanol. When the alcohol-containing protic solvent is a mixed solvent of water and alcohol, the water and alcohol may have a volume ratio of 1:2 to 2:1, for example, 1:1. The freezing point of the mixed solvent may be about −40 degrees (° C.).

The aramid nanoseed suspension layer 100′ immediately after application may contain the organic solvent 120 used during preparing the suspension in the film. However, as the aramid nanoseed suspension layer 100′ is immersed in the alcohol-containing protic solvent, the organic solvent 120 may be substituted with the alcohol-containing protic solvent 220, thereby forming the aramid nanofiber alcohol gel film 200.

Specifically, the alcohol-containing protic solvent may convert an amide anion (—CON⁻—) of the amide groups of the polymer backbones on the surface of the aramid nanoseeds 110 in the suspension layer 100′ into an amide group (—CONH—) by re-protonation, and the hydrogen bond between the amide groups of re-protonated polymer backbone and/or the polymer backbone having the original amide groups may be restored to form a nanofibrillar network 210 having an irregular network of aramid nanofibers by self-assembling polymer backbones. In addition, phase separation between the alcohol-containing protic solvent 220 and the aramid nanofiber network 210 may be induced due to a difference in solubility parameters between the aramid and the alcohol-containing protic solvent. However, the solubility parameters of the aramid and the alcohol-containing protic solvent do not show a very large difference, so that the alcohol-containing protic solvent is impregnated 230 in the aramid nanofiber network 210 and the aramid nanofiber network 210 may be in an alcohol gel state.

Thereafter, the aramid nanofiber alcohol gel film 200 may be immersed in water for a second solvent exchange. Specifically, the alcohol-containing protic solvent 220, 230 may be exchanged for water 320, 330 to form an aramid nanofiber hydrogel film 300 (S40).

The water may be distilled water, and may also contain other solvents other than water. The water (320, 330) has a lower pKa than the alcohol-containing protic solvent (220, 230) and can provide more effective H⁺ ions, so that the hydrogen bond in the aramid nanofiber network 310 can be stronger. In addition to this, the water 320 and 330 may exhibit a greater difference in solubility parameters for aramid compared to the alcohol-containing protic solvent, so that the degree of phase separation may be increased.

Accordingly, the aramid nanofiber hydrogel film 300 may have a lower thickness compared to the aramid nanofiber alcohol gel film 200, and the size of the phase-separated solvent (water) region 320 may be increased and the size of the impregnated solvent (water) region 330 within the aramid nanofiber network may also be slightly increased.

Thereafter, the porous aramid nanofiber film 400 may be prepared by freeze-drying the aramid nanofiber hydrogel film 300 (S50).

The freeze-drying is a process of rapidly sublimating the water in the aramid nanofiber hydrogel film under specific pressure conditions with lowering the temperature below the freezing point of water, and may change the aramid nanofiber hydrogel film into aerogel film by filling the space filled by water with gas.

As a result, the porous aramid nanofiber film 400 may include an aramid nanofiber network 410, micro-sized pores 420, and nano-sized pores 430. Specifically, the micro-sized pores 420 may be regions in which water is removed from the phase-separated solvent (water) region 320 in the aramid nanofiber hydrogel film, and the nano-sized pores 430 may be regions in which water is removed from the impregnated solvent (water) region 330 within the aramid nanofiber networks.

Thereafter, the thickness of the porous aramid nanofiber film may be reduced by pressing. The pressed film may have a thickness of about 10 to 30 μm. Since the film has porosity, it can be easily compressed and reduced in thickness when pressure is applied, for example, the thickness can be reduced by about ¼. This pressurization step may be performed during a secondary battery manufacturing process to be described later. Specifically, during the manufacturing process of a secondary battery, a laminate is formed by sequentially layering the positive electrode, the porous aramid nanofiber film, and the negative electrode, and then, in the process of pressurizing the laminate, the porous aramid nanofiber film is pressed and the thickness may be reduced.

Porous Aramid Nanofiber Film

Referring again to FIG. 2, the porous aramid nanofiber film 400 will be described.

The porous aramid nanofiber film 400 may include an aramid nanofiber network 410 and micro-sized pores 420 and nano-sized pores 430. The micro-sized pores 420 may be the area other than the aramid nanofiber network, that is, aramid framework 410, and the nano-sized pores 430 may be located within the aramid nanofiber network or the aramid framework 410. In other words, since the aramid nanofiber network 410 is a region other than the micro-sized pores 420, it can be referred to as a region defined by the micro-sized pores 420. The porous aramid nanofiber film 400 may be a mesoporous aramid framework, and may include nanopores in the mesoporous aramid framework itself.

The micropores 420 may have a diameter of several to several tens of micrometers, for example, an average diameter of 1 to 100 μm, for example, 30 μm or less, for example, 2 to 25 μm, and the nanopores 430 may have a diameter of a few to several hundred nanometers, for example, 1 to 200 nm, specifically 5 to 100 nm, more specifically 10 to 50 nm. The ratio of the porosity of the micropores 420 relative to the porosity of the nanopores 430 may be 30 to 150, and more specifically, 50 to 120.

The reason why the micropores 420 and the nanopores 430 are mixed in the porous aramid nanofiber film 400 may be as follows, but is not limited to the following theory. When the aramid nanoseed suspension layer is immersed in alcohol or water, nanofibrillization may proceed as hydrogen bonds between the nanoseeds are recovered. Here, water may promote nanofibrillation at a very rapid rate and form strong hydrogen bonds between nanofibers, whereas alcohol promotes nanofibrillation at a relatively slow rate and form relatively weak hydrogen bonds between nanofibers, resulting in a relatively low-density and sparse gelation. In particular, when an alcohol gel is formed through alcohol immersion and then water immersion is performed, the coarse structure is preserved and nanofibrillation further progresses, so that both micro- and nano-sized pores can be obtained. Later, by sublimating all moisture through lyophilization, an aerogel-type film having both micropores and nanopores can be made. In comparison, when immersed in water rather than alcohol from the beginning, higher density gelation proceeds through rapid nanofibrillation and strong hydrogen bonding, and even when freeze-dried, only nano-sized pores due to nanofibrillation may appear, and micro-sized pores may not be created.

This aramid nanofiber film has, at least on one side, micro-sized pores with an average pore diameter of 30 μm or less and nano-sized pores with an average pore size of 100 nm or less, and in addition, even if the film is compressed, it may have a porosity of 80% or more, specifically 80 to 99%.

The porous aramid nanofiber film may be formed to have a thickness of about 30 to 100 μm, for example, 50 to 70 μm before compression, and after compression molding, can have a thickness of about 5 to 30 μm, specifically, 10 to 25 μm.

Secondary Battery

The secondary battery of the present invention can be manufactured according to a conventional method known in the art except using a porous aramid nanofiber film. For example, it may be prepared by inserting the porous aramid nanofiber film prepared by the manufacturing method according to the present invention as a separator between a negative electrode and a positive electrode and injecting an electrolyte. Since the porous aramid nanofiber film is easily compressed and reduced in thickness when pressure is applied, it can be easily inserted into the battery when assembling the battery.

Negative Electrode

The negative electrode may include at least one negative electrode active material layer selected from lithium metal, sodium metal, magnesium metal, or a lithium alloy. As the lithium alloy, an alloy composed of lithium and at least one metal selected from Na, K, Rb, Cs, Fr, Be, Mg, Ca, Sr, Ba, Ra, Al, and Sn may be used. When sodium metal is used as the negative electrode, the battery may be a sodium secondary battery, and when magnesium metal is used as the negative electrode, the battery may be a magnesium secondary battery. In the case of the sodium secondary battery or the magnesium secondary battery, the positive electrode active material and electrolyte described below may be appropriately modified into those containing sodium ion or magnesium ion.

The negative electrode may further include a negative electrode current collector under the negative electrode active material layer. The negative electrode current collector is generally made to have a thickness of 3 to 500 μm. The negative electrode current collector is not particularly limited as long as it has conductivity without causing chemical change to the battery, and for example, copper, stainless steel, aluminum, nickel, titanium, fired carbon, a copper or stainless steel surface treated with carbon, nickel, titanium, silver, etc., or an aluminum-cadmium alloy, etc. may be used. In addition, like a positive electrode current collector, fine irregularities may be formed on the surface to enhance the bonding strength with the negative electrode active material, and may be used in various forms such as films, sheets, foils, nets, porous bodies, foams, and nonwoven fabrics.

In another embodiment, the negative electrode may be manufactured by preparing a slurry by mixing and stirring negative electrode active material particles with a solvent, if necessary, a binder, a conductive material, and a dispersant, and then applying (coating) the slurry to the negative electrode current collector, compressing, and drying.

The negative electrode active material particles may be used without limitation as long as they are generally used in the art, and carbon materials may be used in general. Examples of usable carbon materials include low crystalline carbon and high crystalline carbon. Soft carbon and hard carbon are typical examples of the low crystalline carbon, and natural graphite and high-temperature calcined carbon such as kish graphite, pyrolytic carbon, mesophase pitch based carbon fiber, meso-carbon microbeads, mesophase pitches, and petroleum or coal tar pitch derived cokes are typical examples of the high crystalline carbon. The carbon material may have an average particle diameter of a conventional negative electrode active material. For example, it may be 3 to 60 μm, but is not limited thereto.

The conductive material may be used without limitation as long as it is generally usable in the art, and for example, artificial graphite, natural graphite, carbon black, acetylene black, ketjen black, denka black, thermal black, channel black, carbon fiber, metal fiber, aluminum, tin, bismuth, silicon, antimony, nickel, copper, titanium, vanadium, chromium, manganese, iron, cobalt, zinc, molybdenum, tungsten, silver, gold, lanthanum, ruthenium, platinum, iridium, titanium oxide, polyaniline, polythiophene, polyacetylene, polypyrrole, or mixtures thereof may be used.

The binder can be used without limitation as long as it is generally used in the art, for example, polyvinylidene fluoride (PVdF), polyhexafluoropropylene-polyvinylidene fluoride copolymer (PVdF/HFP), poly(vinyl acetate), polyvinyl alcohol, polyethylene oxide, polyvinylpyrrolidone, polyvinylpyridine, alkylated polyethylene oxide, polyvinyl ether, poly(methyl methacrylate), poly(ethyl acrylate), polytetrafluoroethylene (PTFE), polyvinylchloride, polyacrylonitrile, styrene-butadiene rubber, acrylonitrile-butadiene rubber, fluororubber, ethylene-propylene-diene monomer (EPDM), sulfonated ethylene-propylene-diene monomer, carboxymethylcellulose (CMC), regenerated cellulose, starch, hydroxypropyl cellulose, tetrafluoroethylene, or a mixture thereof may be used.

Positive Electrode

The positive electrode may be manufactured by a conventional method known in the art, and may vary depending on the specific type of secondary battery.

Specifically, when the secondary battery is a lithium ion battery, the positive electrode may contain a positive electrode active material, a binder, and a conductive material. A positive electrode active material of a lithium ion battery may contain a lithium-transition metal oxide or a lithium-transition metal phosphate. The lithium-transition metal oxide may be a composite oxide of lithium and at least one transition metal selected from the group consisting of cobalt, manganese, nickel, and aluminum. Lithium-transition metal oxides are, for example, Li(Ni_{1-x-y}CoₓMn_{y})O₂ (0≤x≤1, 0≤y≤1, 0≤x+y≤1), Li(Ni_{1-x-y}CoₓAl_{y})O₂ (0≤x≤1, 0<y≤1, 0<x+y≤1), or Li(Ni_{1-x-y}CoₓMn_{y})₂O₄ (0≤x≤1, 0≤y≤1, 0≤x+y≤1). The lithium-transition metal phosphate may be a composite phosphate of lithium and at least one transition metal selected from the group consisting of iron, cobalt, and nickel. The lithium-transition metal phosphate may be, for example, Li(Ni_{1-x-y}CoₓFe_{y})PO₄ (0≤x≤1, 0≤y≤1, 0≤x+y≤1).

When the secondary battery is a lithium sulfur battery, the positive electrode may contain a sulfur compound as a positive electrode active material, and may further contain a binder and a conductive material. The sulfur compound may be solid sulfur (S₈) and/or Li₂S.

When the secondary battery is a lithium-air battery, the positive electrode may contain a carbon material, a catalyst for oxidation-reduction of oxygen, or a combination thereof. The carbon material may include carbon black (super P, ketjen black, etc.), carbon nanotube (CNT), graphite, graphene, porous carbon, or a combination thereof. The catalyst for oxidation-reduction of oxygen may be a transition metal, a transition metal oxide, or a transition metal carbide. The transition metal is ruthenium (Ru), palladium (Pd), iridium (Ir), cobalt (Co), nickel (Ni), iron (Fe), silver (Ag), manganese (Mn), platinum (Pt), gold (Au), nickel (Ni), copper (Cu), aluminum (Al), chromium (Cr), titanium (Ti), silicon (Si), molybdenum (Mo) tungsten (W), or combinations thereof. The transition metal oxides include ruthenium dioxide (RuO₂), iridium dioxide (IrO₂), cobalt tetraoxide (Co₃O₄), manganese dioxide (MnO₂), cerium dioxide (CeO₂), iron trioxide (Fe₂O₃), iron tetraoxide (Fe₃O₄), and nickel monoxide (NiO), copper oxide (CuO), a perovskite-based catalyst, or a combination thereof. The transition metal carbide may include a titanium carbide (TiC), silicon carbide (SiC), tungsten carbide (WC), molybdenum carbide (MoC)-based catalyst, or a combination thereof.

The positive electrode current collector is generally made to have a thickness of 3 to 500 μm. The positive electrode current collector is not particularly limited as long as it has conductivity without causing chemical change to the battery. Specifically, the positive electrode current collector may be any metal that does not cause chemical change to the battery, has high conductivity, can easily adhere to the slurry of the positive electrode active material, and does not have reactivity in the voltage range of the battery. Non-limiting examples of the positive electrode current collector include a foil made of aluminum, nickel, or a combination thereof.

Examples of the solvent for forming the positive electrode include organic solvents such as NMP (N-methyl pyrrolidone), DMF (dimethyl formamide), acetone, and dimethyl acetamide, or water, and these solvents may be used alone or may be used in mixture of two or more.

The amount of solvent used may be adjusted to dissolve and disperse the electrode active material, the binder, and the conductive material in consideration of the coating thickness of the slurry and the manufacturing yield.

Since the conductive material and the binder overlap with those described in the description of the negative electrode, description thereof is omitted.

In the positive electrode, if necessary, a filler may be further added to the mixture. The filler may be selectively used as a component that suppresses expansion of the positive electrode, and may not be particularly limited as long as it is a fibrous material without causing chemical change in the battery, and examples thereof include olefinic polymers such as polyethylene and polypropylene, or fibrous materials such as glass fibers and carbon fibers.

Separator

A porous aramid nanofiber film according to the present invention may be used as a separator between the negative electrode and the positive electrode for insulating the electrodes.

The secondary battery according to the present invention may include the porous aramid nanofiber film, and since the porous aramid nanofiber film is as described above, detailed description is omitted to avoid redundant description. However, micropores and nanopores may be irregularly arranged in the porous aramid nanofiber film, and the nanopores may inhibit dendrite formation and the micropores may help fast conduction of lithium ions to enable high-speed charging and discharging.

The porous aramid nanofiber film may be compression molded to have a thickness of about 5 to 30 μm, specifically, 10 to 25 μm.

The separator may be a single membrane of the porous aramid nanofiber film or a laminate of the porous aramid nanofiber film on a conventional porous polymer film used as a separator, but is not limited thereto. The conventional porous polymer film may be a polyolefin-based porous polymer film such as ethylene homopolymer, propylene homopolymer, ethylene/butene copolymer, ethylene/hexene copolymer and ethylene/methacrylate copolymer.

Electrolyte

A battery may be manufactured by accommodating the electrode assembly having the above structure in a pouch exterior material and then injecting an electrolyte solution. However, it is not limited thereto, and may be manufactured in various forms such as coin cells. In the case of a coin cell, an electrolyte solution may be coated.

The electrolyte solution may be a lithium salt-containing non-aqueous electrolyte, which may include a non-aqueous electrolyte solution and a lithium salt.

Examples of the nonaqueous electrolyte may include an aprotic organic solvent such as N-methyl-2-pyrrolidinone, propylene carbonate, ethylene carbonate, butylene carbonate, dimethyl carbonate, diethyl carbonate, gamma-butylolactone, 1,2-dimethoxyethane, tetrahydroxyfuran, 2-methyl tetrahydrofuran, dimethylsulfoxide, 1,3-dioxorane, formamide, dimethylformamide, dioxorane, acetonitrile, nitromethane, methyl formate, methyl acetate, phosphoric acid triesters, trimethoxy methane, dioxorane derivatives, sulfolane, methyl sulfolane, 1,3-dimethyl-2-imidazolidinone, propylene carbonate derivatives, tetrahydrofuran derivative, ether, methyl propionate, or ethyl propionate.

The lithium salt may be a material that is easily soluble in the non-aqueous electrolyte, and may be, for example, LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, (CF₃SO₂)₂NLi, lithium chloroborane, lithium lower aliphatic carboxylate, lithium 4-phenyl borate, imide and the like.

In addition, the non-aqueous electrolyte may include, for example, pyridine, triethylphosphite, triethanolamine, cyclic ether, ethylene diamine, n-glyme, hexaphosphoric acid triamide, nitrobenzene derivative, sulfur, quinone imine dye, N-substituted oxazolidinone, N,N-substituted imidazolidine, ethylene glycol dialkyl ether, ammonium salt, pyrrole, 2-methoxy ethanol, aluminum trichloride and the like to improve charge/discharge characteristics, flame retardancy, and the like. In some cases, the non-aqueous electrolyte may contain a halogen-containing solvent such as carbon tetrachloride or ethylene trifluoride to have incombustibility, or may contain carbon dioxide gas to improve storage characteristics at high temperatures.

Battery Module

The secondary battery according to the present invention can be used not only in a battery module used as a power source for a small device, but also as a unit cell in a medium or large-sized battery pack including a plurality of batteries. A battery module according to another embodiment of the present invention may include the above-described secondary battery as a unit cell, and a battery pack according to another embodiment of the present invention may include the battery module.

Examples of the medium-to-large-sized device include, but are not limited to, electric vehicles, hybrid electric vehicles, plug-in hybrid electric vehicles, power storage systems, and the like.

As the battery case used in the present invention, those commonly used in the art may be adopted, and there is no limitation on the external appearance according to the purpose of the battery, for example, a cylindrical shape using a can, a prismatic shape, a pouch shape, or a coin type, etc.

Hereinafter, a preferred experimental example is presented to help understanding of the present invention. However, the following experimental examples are only to aid the understanding of the present invention, and the present invention is not limited by the following experimental examples.

### Separator Preparation Examples: Preparation Examples 1 to 5 and Comparative Examples 1 to 3

### Preparation Example 1: Preparation of Porous Aramid Nanofiber Film

After putting 1.1 g aramid fiber (Kevlar fiber, DuPont) in a 250 ml bottle, 1.1 g of KOH was added thereto and 100 ml of DMSO was added thereto. Thereafter, a stirring bar was put in, the lid was closed, and stirring was performed at 26.5° C., 200 rpm for about 2 weeks. When the aramid fibers were not visible in the result and the result had a reddish color, the stirring was stopped to obtain a 1 wt % aramid nanoseed suspension. This 1 wt % aramid nanoseed suspension was coated to a glass substrate at 0.15 ml/cm². The coating was performed using spin coating, and was performed at 300 rpm for 30 seconds. Thereafter, the substrate including the coated aramid nanoseed film was immersed in ethanol for 30 minutes to perform first solvent exchange, and after 30 minutes, immersed in distilled water for 30 minutes to perform second solvent exchange. After solvent exchange, an aramid nanofiber hydrogel was formed, and the formed hydrogel was freeze-dried at 30 mmTorr or less and −50 degrees or less to prepare a porous aramid nanofiber film. After that, the porous aramid nanofiber film was detached from the substrate.

### Preparation Example 2

A porous aramid nanofiber film was prepared in the same manner as in Preparation Example 1, except that the 1 wt % aramid nanoseed suspension was applied in an amount of 0.08 ml/cm² to a silicon mold substrate having a mold height of 100 μm instead of the glass substrate.

### Preparation Example 3

A porous aramid nanofiber film was prepared in the same manner as in Preparation Example 1, except that the 1 wt % aramid nanoseed suspension was applied to the glass substrate at 0.15 ml/cm² using blade coating instead of spin coating.

### Preparation Example 4

A porous aramid nanofiber film was prepared in the same manner as in Preparation Example 1, except that the substrate was immersed in a mixture of ethanol and distilled water 1:1 (v:v) instead of the ethanol immersion process in the solvent exchange step.

### Preparation Example 5

A porous aramid nanofiber film was prepared in the same manner as in Preparation Example 3, except that the substrate was immersed in a mixture of ethanol and distilled water 1:1 (v:v) instead of the ethanol immersion process in the solvent exchange step.

### Comparative Example 1

A porous aramid nanofiber film was prepared in the same manner as in Preparation Example 1, except that the ethanol immersion process was not performed and the substrate was immersed only in distilled water for 30 minutes in the solvent exchange step.

### Comparative Example 2

A porous aramid nanofiber film was prepared in the same manner as in Comparative Example 1, except that a 1 wt % aramid nanofiber (ANF) solution was applied to the glass substrate at 0.15 ml/cm² using blade coating instead of spin coating.

### Comparative Example 3

A polypropylene membrane (Celgard 3501) commercially available as a separator for a lithium secondary battery was used.

The preparation conditions of the porous aramid nanofiber films of Preparation Examples 1 to 5 and Comparative Examples 1 to 2 are summarized in Table 1 below.

TABLE 1

| | Aramid Nanoseed Suspension | | | | |
|---|---|---|---|---|---|
| | Application Step | | | | |
| | | Aramid | | | |
| | | Nanoseed | | Solvent Exchange Step | |
| | | Suspension | | First | Second |
| | | Application | | Solvent | Solvent |
| | | Amount | Application | Exchange | Exchange |
| | Substrate | (ml/cm²) | method | Step | Step |
| Preparation | glass | 0.15 | spin coating | ethanol | distilled |
| Example 1 | | | | | water |
| Preparation | silicon | 0.08 | spin coating | ethanol | distilled |
| Example 2 | mold | | | | water |
| Preparation | glass | 0.15 | blade coating | ethanol | distilled |
| Example 3 | substrate | | | | water |
| Preparation | glass | 0.15 | spin coating | ethanol/distilled | distilled |
| Example 4 | substrate | | | water (1:1) | water |
| | | | | mixture | |
| Preparation | glass | 0.15 | blade coating | ethanol/distilled | distilled |
| Example 5 | substrate | | | water (1:1) | water |
| | | | | mixture | |
| Comparative | glass | 0.15 | spin coating | — | distilled |
| Example 1 | substrate | | | | water |
| Comparative | glass | 0.15 | blade coating | — | distilled |
| Example 2 | substrate | | | | water |

### Preparation of Secondary Battery: Preparation Examples 6 to 10 and Comparative Examples 4 to 6

### Preparation Example 6

A CR2032 coin cell was assembled as a lithium secondary battery in an argon atmosphere glove box. Specifically, lithium foil was used as both a positive electrode and a negative electrode, and 120 μl of a solution in which 1M LiPF₆ salt was dissolved in a mixed solvent of EC:DEC:DMC=1:1:1 was used as an electrolyte, and a porous aramid nanofiber film prepared in Preparation Example 1 was used as a separator.

### Preparation Examples 7 to 10

Lithium secondary batteries according to Preparation Examples 7 to 10 were prepared in the same manner as in Preparation Example 6, except for using the porous aramid nanofiber films prepared in Preparation Examples 2 to 5 instead of Preparation Example 1 as separators, respectively.

### Comparative Examples 4 and 5

Lithium secondary batteries according to Comparative Examples 4 and 5 were prepared in the same manner as in Preparation Example 6, except for respectively using the porous aramid nanofiber films prepared in Comparative Examples 1 to 2 instead of Preparation Example 1 as separators.

### Comparative Example 6

A lithium secondary battery was prepared in the same manner as in Preparation Example 6, except that a commercially available polypropylene membrane (Celgard 3501) of Comparative Example 3 was used as a separator instead of the porous aramid nanofiber film.

### Experimental Example

### Experimental Example 1: Observation of Surface Characteristics of Separator

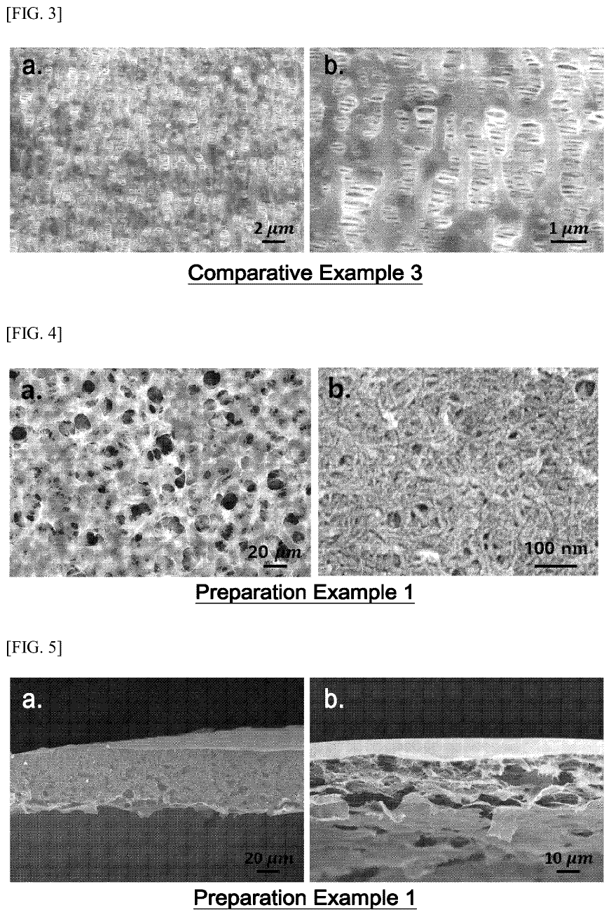

FIG. 3 shows a field emission scanning electron microscope (FE-SEM) images taken at (a) low magnification and (b) high magnification of a commercially available polypropylene (Celgard 3501) separator according to Comparative Example 3, and FIG. 4 shows FE-SEM images taken at (a) low magnification and (b) high magnification of the porous aramid nanofiber film prepared according to Preparation Example 1 of the present invention. FIG. 5 shows FE-SEM images of cross-sections of the porous aramid nanofiber film prepared according to Preparation Example 1 of the present invention (a) before applying pressure and (b) after applying pressure.

Referring to FIGS. 3 and 4, the aramid nanofiber film according to the present invention is provided with nanopores having an average diameter of about 10 nm or less together with micropores having an average diameter of about 300 μm or less, unlike the polypropylene separator.

In addition, as shown in FIG. 5, the aramid nanofiber film according to the present invention had a thickness of about 60 μm before pressure was applied (a), but after a pressure similar to that applied during lithium secondary battery manufacturing was applied, it was confirmed that the film was not broken while being reduced to a thickness of about 18 μm, that is about ¼ the thickness before pressure is applied. From this, it was confirmed that the aramid nanofiber film according to the present invention can be compressible without being broken.

### Experimental Example 2: Change in Surface Characteristics of Separator According to Solvent Exchange Step

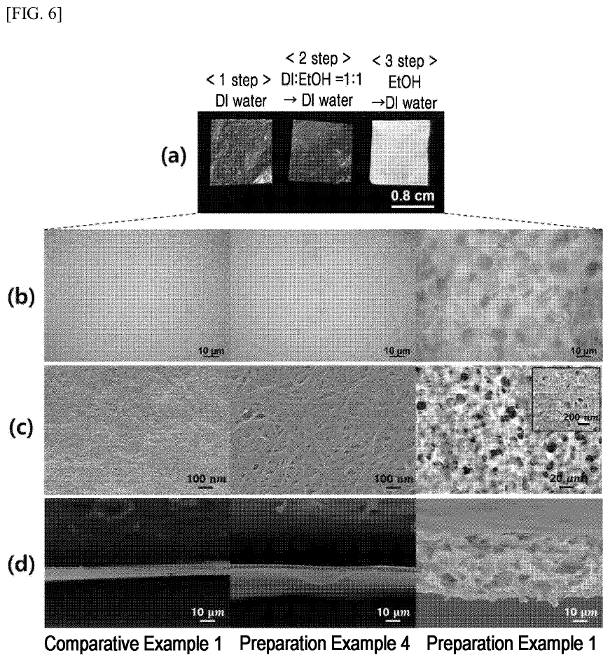

FIG. 6 shows (a) surface photographs, (b) optical microscope (OM) images, (c) surface FE-SEM images, and (d) cross-sectional FE-SEM images of aramid nanofiber films according to Preparation Example 1, Preparation Example 4, and Comparative Example 1 with different solvent exchange methods.

Referring to FIG. 6, in the aramid nanofiber film obtained in Comparative Example 1, which was subjected to one solvent exchange step using distilled water, only nanopores having an average diameter of several nm less than 10 nm were observed. The aramid nanofiber film obtained in Preparation Example 4, which has undergone a two-step solvent exchange step of first solvent exchange with a mixed solution of ethanol and distilled water and then second solvent exchange with distilled water, has nanopores with an average diameter of about 50 nm. The pore size slightly increased compared to Comparative Example 1, but nano-sized pores were still observed. On the other hand, the aramid nanofiber film obtained in Preparation Example 1, which has undergone a two-step solvent exchange step of first solvent exchange with ethanol and then second solvent exchange with distilled water, has nano-sized pores and simultaneously has micropores of about 2-25 μm.

The films produced in this way had a thickness of 1.7 μm (Comparative Example 1), 3 μm (Preparation Example 4), and 50 μm (Preparation Example 1). As such, compared to the film according to Comparative Example 1 in which the solvent was exchanged with distilled water only, the thickness and pore size of the film according to Preparation Example 4 in which the solvent was exchanged with a mixed solution of alcohol and distilled water and then the solvent was exchanged with distilled water increased.

On the other hand, when the solvent was exchanged with alcohol and then the solvent was exchanged with distilled water (Preparation Example 1), the thickness and pore size of the film further increased. It was understood that this was because the gelation proceeded in a low density and relatively coarse state as the nanofibrillation progressed at a relatively slow rate and the bonding force between nanofibers was relatively low during the first solvent exchange step with alcohol; and the nanofibrillation proceeded further while the coarse structure was preserved during the second solvent exchange step with water.

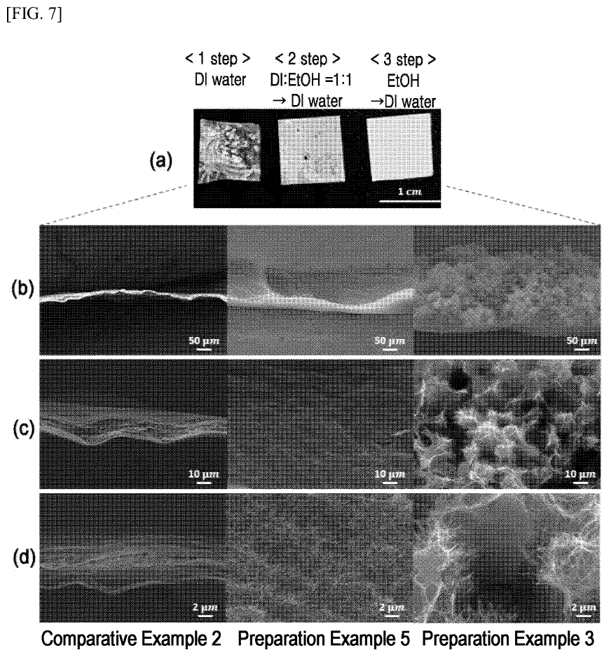

FIG. 7 shows (a) surface photographs, (b), (c), and (d) cross-sectional FE-SEM images of aramid nanofiber films according to Preparation Example 3, Preparation Example 5, and Comparative Example 2 with different solvent exchange methods. However, in Preparation Example 3, Preparation Example 5, and Comparative Example 2, a relatively thick thin film was formed with a larger amount of aramid nanoseed suspension applied compared to Preparation Example 1, Preparation Example 4, and Comparative Example 1 described in FIG. 6.

Referring to FIG. 7, the aramid nanofiber film formed thickly obtained in Comparative Example 2, which was subjected to one solvent exchange step using distilled water, has a very dense surface, so micro-sized pores are not generated. The aramid nanofiber film obtained in Preparation Example 5, which has undergone a two-step solvent exchange step of first solvent exchange with a mixed solution of ethanol and distilled water and then second solvent exchange with distilled water, has nanopores with an average diameter of about 100 nm or less. The pore size slightly increased, but nano-sized pores were still observed. On the other hand, the aramid nanofiber film obtained in Preparation Example 3, which has undergone a two-step solvent exchange step of first solvent exchange with ethanol and then secondary solvent exchange with distilled water, has nano-sized pores of about 100 nm or less and simultaneously has micropores of about 30 μm or less.

Therefore, in the solvent exchange step of the manufacturing process for the porous aramid nanofiber film according to the present invention, the first solvent exchange step using ethanol and the second solvent exchange step using distilled water were performed, thereby forming nano-sized pores as well as micro-sized pores on the surface of the porous aramid nanofiber film.

The films produced in this way had a thickness of 8 μm (Comparative Example 2), 140 μm (Preparation Example 5), and 300 μm (Preparation Example 3).

### Experimental Example 3: Measurement of Porosity, Pore Size and Pore Volume of Film

In order to find out the porosity, pore size and pore volume of the porous aramid nanofiber film prepared by the preparation method according to the present invention, the following experiments were performed.

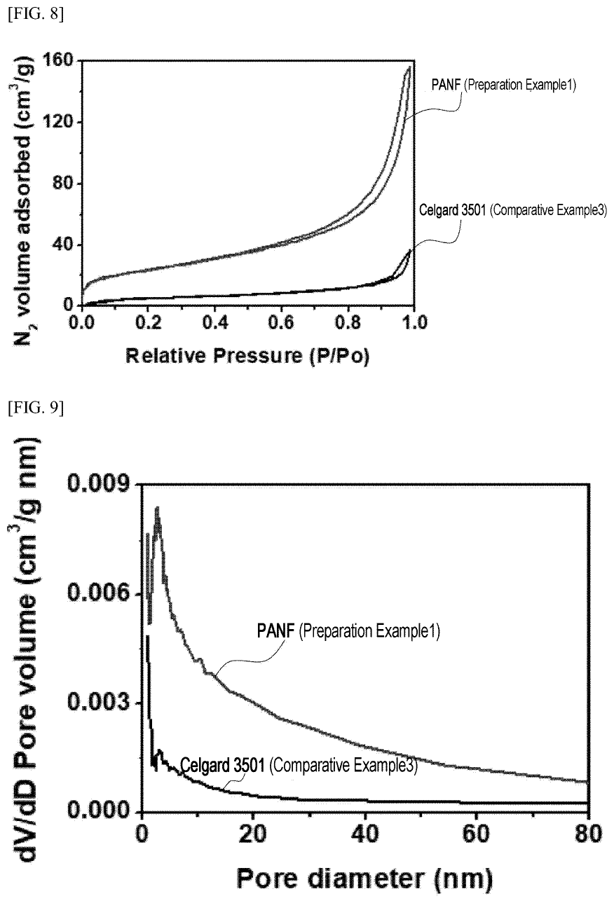

Specifically, with respect to the porous aramid nanofiber film prepared in Preparation Example 1 and the polypropylene film (Celgard 3501) of Comparative Example 3, the pore size, pore volume and BET surface area were measured through nitrogen gas adsorption method (BET) analysis. The results are shown in FIGS. 8 and 9 and Table 2 below. However, since BET analysis can analyze only nano-sized pores, the following BET measurement results, that is, pore size, pore volume, and BET surface area, are for only nano-sized pores excluding micro-pores.

Here, the porosity was calculated by the following Equation 1 separately from the BET measurement.

Porosity=1−ρ_{gel}/ρ_{solid} [Equation 1]

In Equation 1, ρ_{gel} is the density of the aerogel state, and ρ_{solid} is the density of the pure solid state without pores.

FIG. 8 is a graph showing N₂ adsorption-desorption isotherms of an aramid nanofiber film prepared according to Preparation Example 1 and a polypropylene film (Celgard 3501) according to Comparative Example 3.

FIG. 9 is a graph showing the distribution of the pore size of the aramid nanofiber film prepared according to Preparation Example 1 and the polypropylene film (Celgard 3501) according to Comparative Example 3.

TABLE 2

| | | | | | | BET | |
|---|---|---|---|---|---|---|---|
| | | nanopore | micropore | micropore/ | pore | surface | pore |
| | porosity | porosity | porosity | nanopore | size | area | volume |
| | (%) | (%) | (%) | ratio | (nm) | (m²/g) | (cm³/g) |
| Comparative | 47.6 ± 1.0 | 2.7 | 34.9 | 13 | 10.4 | 21.1 | 0.054 |
| Example 3 | | | | | | | |
| (Celgard | | | | | | | |
| 3501) | | | | | | | |
| Preparation | 97.2 ± 0.1 | 0.9 | 96.3 | 107 | 11.2 | 81.6 | 0.228 |
| Example 1 | | | | | | | |
| (PANF) | | | | | | | |
| Preparation | 89.0 ± 0.6 | — | — | | — | — | — |
| Example 1 | | | | | | | |
| (PANF) | | | | | | | |
| (after | | | | | | | |
| pressure is | | | | | | | |
| applied) | | | | | | | |

The nanopore porosity in Table 2 was obtained by converting the BET measurement results, and the micropore porosity is an estimate obtained by subtracting the nanopore porosity from the total porosity. The micropore/nanopore ratio is an estimated calculated value using this.

As shown in FIGS. 8, 9 and Table 2, the aramid nanofiber film according to the present invention had a porosity of about 97% before pressure was applied; and even after pressure was applied, the aramid nanofiber film prepared according to the present invention showed a high porosity of about 89%. It was confirmed that the porosity was about twice as high as that of the currently commercialized polypropylene membrane (Celgard 3501) (about 47%).

In addition, the BET surface area of the aramid nanofiber film according to the present invention was 81.6 m²/g, and the nanopore volume was 0.228 cm³/g. From this, compared to the BET surface area (21.1 m²/g) and nanopore volume (0.054 cm³/g) of the currently commercialized polypropylene membrane (Celgard 3501), it was confirmed that the aramid nanofiber film according to the present invention had about 4 times larger nano pore volume.

Therefore, since the aramid nanofiber film prepared according to the present invention exhibits a high porosity and pore volume, it is easy to transfer ions in the electrolyte of a secondary battery, so it can be usefully used as a separator.

### Experimental Example 4: Evaluation of Thermal Stability of Separator

In order to examine the thermal stability of the porous aramid nanofiber film prepared by the preparation method according to the present invention, the following experiment was performed.

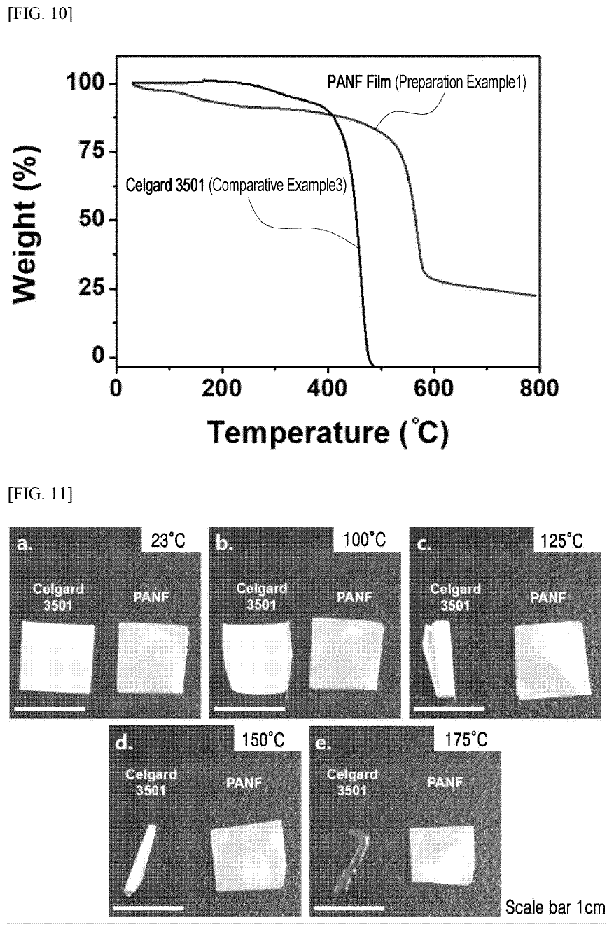

Specifically, thermogravimetric analysis was performed on the porous aramid nanofiber film (PANF) prepared in Preparation Example 1 and the polypropylene film (Celgard 3501) of Comparative Example 3, and the results are shown in FIG. 10.

FIG. 10 is a graph showing the results of thermogravimetric analysis of separators according to Preparation Example 1 and Comparative Example 3.

As shown in FIG. 10, in the case of Celgard 3501, which was used as a conventional separator, it started to decompose at about 400° C. and was all burned before reaching 500° C., but the porous aramid nanofiber film (PANF) according to the present invention did not decompose until reaching 500° C. Therefore, it was confirmed that the thermal stability of the porous aramid nanofiber film (PANF) was excellent.

In addition, the degree of thermal shrinkage was observed through heat treatment at different temperatures for the porous aramid nanofiber film (PANF) prepared in Preparation Example 1 and the polypropylene film (Celgard 3501) of Comparative Example 3, and the results are shown in FIG. 11.

FIG. 11 shows photographs indicating the degree of thermal contraction of the separators according to Preparation Example 1 and Comparative Example 3 during heat treatment at different temperatures.

As shown in FIG. 11, in the case of Celgard 3501, which was used as a conventional separator, shrinkage began to occur at 100° C., and as the temperature increased, the separator gradually rolled up, and it was partially melted at 175° C., and therefore showed low thermal stability. However, it is confirmed that the porous aramid nanofiber film (PANF) according to the present invention has excellent thermal stability by maintaining its shape without shrinkage even after heat treatment at 175° C.

### Experimental Example 4: Electrolyte Wettability Evaluation of Separator

In order to examine the electrolyte mobility of the porous aramid nanofiber film prepared by the manufacturing method according to the present invention, the following experiment was performed.

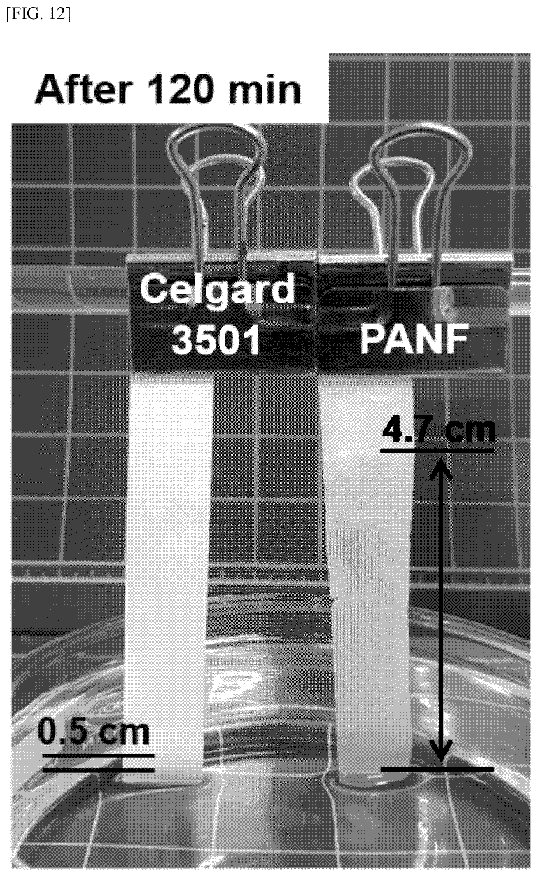

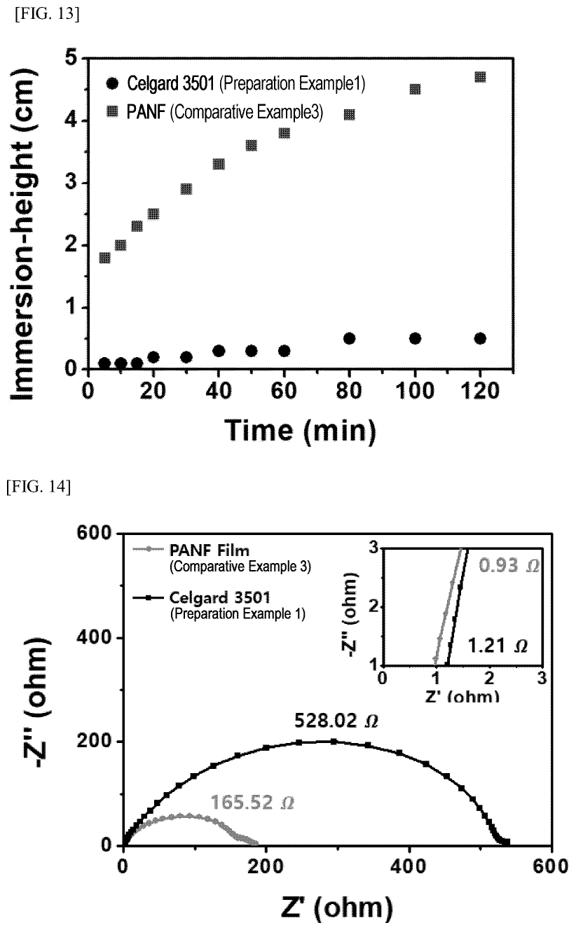

Specifically, the porous aramid nanofiber film (PANF) prepared in Preparation Example 1 and the polypropylene film (Celgard 3501) of Comparative Example 3 were cut to a certain size and slightly immersed in an electrolyte solution, and the wettability of the electrolyte solution over time was measured and shown in FIGS. 12 and 13.

FIG. 12 is a photograph showing the results of the electrolyte wettability test of the separators according to Preparation Example 1 and Comparative Example 3. FIG. 13 is a graph showing the electrolyte wettability over time of separators according to Preparation Example 1 and Comparative Example 3.

As shown in FIGS. 12 and 13, when the porous aramid nanofiber film (PANF) according to the present invention is partially immersed in the electrolyte, the wetting height of the electrolyte increases with time and the wetting height reaches 4.7 cm after 2 hours. From this result, compared to Celgard 3501 (0.5 cm), which was used as a conventional separator, the PANF according to the present invention exhibited wettability of the electrolyte more than 9 times. Therefore, since the PANF according to the present invention has nano-sized pores as well as micro-sized pores, and the pore volume and surface area are large, the movement of electrolyte ions is improved, therefore it can be used as a separator of a secondary battery.

### Experimental Example 5: Electrochemical Characteristics Evaluation of Separator

In order to examine the electrochemical properties of the porous aramid nanofiber film prepared by the manufacturing method according to the present invention, the Following Experiments were Performed.

(1) Measurement of Impedance and Ionic Conductivity

For the PANF prepared in Preparation Example 1 and the polypropylene film (Celgard 3501) of Comparative Example 3, impedance, film thickness and ionic conductivity were measured to analyze resistance among electrochemical properties, and shown in FIG. 14 and Table 3 below.

FIG. 14 is a graph showing the impedance (interface resistance) of the separator according to Preparation Example 1 and Comparative Example 3, and the inset shows the bulk resistance.

TABLE 2

| | film | bulk | interface | ionic |
|---|---|---|---|---|
| | thickness | resistance | resistance | conductivity |
| | (μm) | (Ω) | (Ω) | (mS/cm) |
| Comparative Example | 25 | 1.21 | 528.02 | 1.033 |
| 3 (Celgard 3501) | | | | |
| Preparation Example | 20 | 0.93 | 165.52 | 1.075 |
| 1 (PANF) | | | | |

Referring to FIG. 14, in the case of interfacial resistance, Celgard 3501 showed 528Ω and PANF showed 165Ω, confirming that the interfacial resistance of the PANF according to the present invention was lower. In addition, referring to the inset of FIG. 14, the bulk resistance of Celgard 3501 was 1.21Ω and PANF was 0.93Ω, so it was confirmed that the bulk resistance of the PANF according to the present invention was also lower. As a result of calculating the ionic conductivity through the bulk resistance, as shown in Table 3, the ionic conductivity of the PANF according to the present invention was slightly higher. Therefore, the PANF according to the present invention has low interfacial resistance and higher ion conductivity than the conventional Celgard 3501 separator, so it can be usefully used as a secondary battery separator instead of the conventional separator.

(2) Evaluation of Cycle Characteristics of a Li/Li Symmetrical Cell Including a Separator

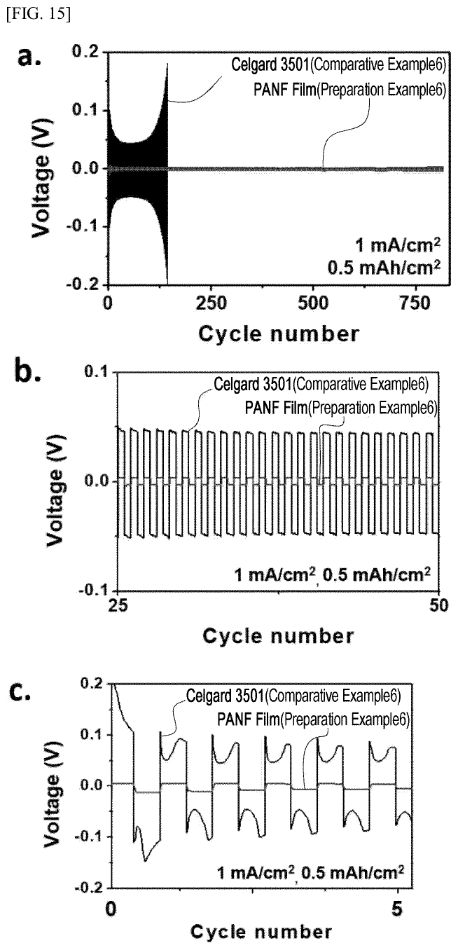

FIGS. 15 to 17 show cycle characteristics of Li/Li symmetric cells according to Preparation Example 6 and Comparative Example 6 using the separators according to Preparation Example 1 and Comparative Example 3, respectively.

Specifically, FIG. 15(a) is a graph showing the constant current cycling test results for 800 cycles for the Li/Li symmetric cell according to Preparation Example 6 including the PANF prepared in Preparation Example 1 and the Li/Li symmetric cell according to Comparative Example 6 including a polypropylene film (Celgard 3501) of Comparative Example 3. FIG. 15(b) is an enlarged view of the 25-50 cycle section of FIG. 15(a), and FIG. 15(c) is an enlarged view of the 0-5 cycle section of FIG. 15(a). In the constant current cycling test, a current density of 1 mA/cm² and a cycle capacity of 0.5 mAh/cm² were used.

As a result, as shown in FIG. 15, in the case of the Li/Li symmetric cell according to Comparative Example 6 including a polypropylene film (Celgard 3501), the cycle life stopped at about 80 cycles, indicating low cycling stability. However, it was confirmed that the Li/Li symmetric cell according to Preparation Example 6 including the PANF according to the present invention stably maintained its cycle life even at about 800 cycles, which is 10 times greater than the Li/Li symmetric cell according to Comparative Example 6.

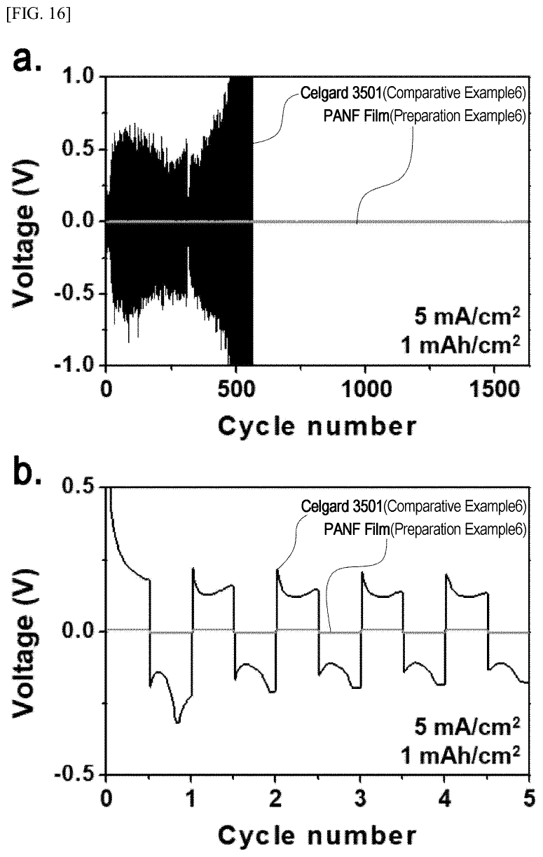

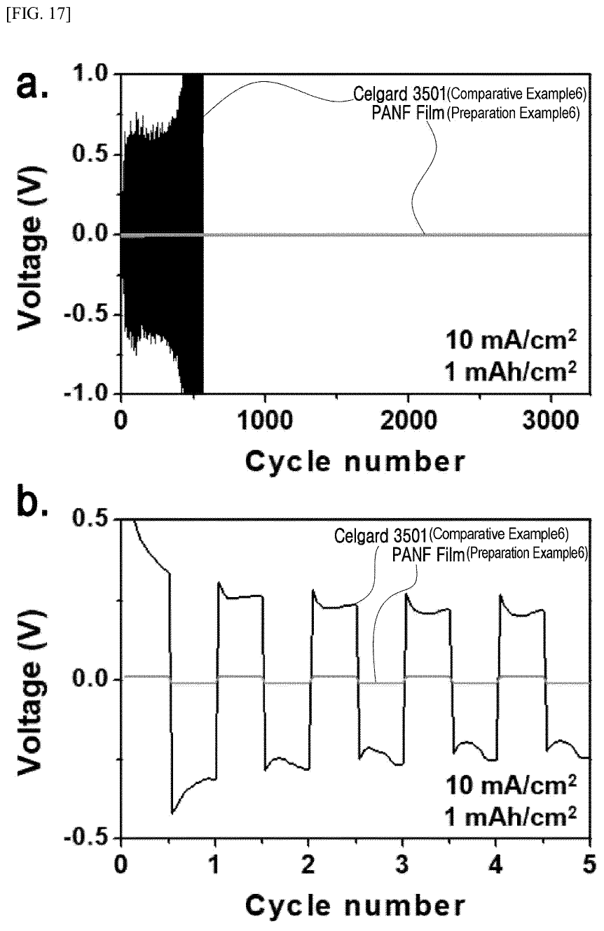

FIG. 16 shows graphs indicating the constant current cycling test results for the Li/Li symmetric cell according to Preparation Example 6 including the PANF prepared in Preparation Example 1 and the Li/Li symmetric cell according to Comparative Example 6 including a polypropylene film (Celgard 3501) of Comparative Example 3 at a current density of 5 mA/cm² and a cycle capacity of 1 mAh/cm². FIG. 17 shows graphs indicating the constant current cycling test results at a current density of 10 mA/cm² and a cycle capacity of 1 mAh/cm².

As a result, as shown in FIG. 16, the life of the Li/Li symmetric cell containing Celgard 3501 at a current density of 5 mA/cm² stopped at about 18 cycles, but the Li/Li symmetric cell including the PANF according to the present invention maintained a stable cycle even at about 1800 cycles, which is 100 times greater than the Li/Li symmetric cell according to Comparative Example 6. The voltage of the Li/Li symmetric cell containing Celgard 3501 was about 215 mV, but the voltage of the Li/Li symmetric cell containing the PANF according to the present invention was about 5 mV. The voltage of the cell including the PANF is about 43 times lower, which is a result of the very small impedance.

In addition, as shown in FIG. 17, the life of the Li/Li symmetric cell containing Celgard 3501 at a current density of 10 mA/cm² stopped at about 15 cycles, but the Li/Li symmetric cell including the PANF according to the present invention maintained a stable cycle even at about 3000 cycles, which is 200 times greater than the Li/Li symmetric cell according to Comparative Example 6. The voltage of the Li/Li symmetric cell containing Celgard 3501 was about 305 mV, but the voltage of the Li/Li symmetric cell containing the PANF according to the present invention was about 11 mV. The voltage of the cell including the PANF is about 30 times lower.

Furthermore, the polarization curve of the cell including Celgard 3501 was found to be greatly bent, but the cell including the PANF according to the present invention showed a straight polarization curve, confirming that the cell including the PANF was stable.

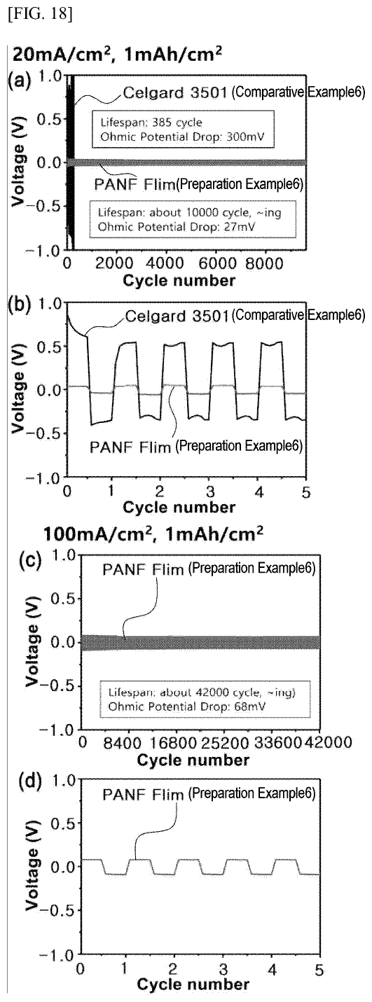

FIG. 18 shows graphs indicating the constant current cycling test results for the Li/Li symmetric cell according to Preparation Example 6 including the PANF prepared in Preparation Example 1 and the Li/Li symmetric cell according to Comparative Example 6 including a polypropylene film (Celgard 3501) of Comparative Example 3 at a current density of 20 mA/cm² and a cycle capacity of 1 mAh/cm² (a, b) and at a current density of 100 mA/cm² and a cycle capacity of 1 mAh/cm² (c, d).

Referring to FIG. 18, in the case of a cell having the PANF, the cycle proceeds very stably even at 10000 cycles or 42000 cycles or more even if the current density is increased to 20-100 mA/cm². However, in the case of a cell having Celgard 3501, a short circuit occurred at 385 cycles (@ current density 20 mA/cm², cycle capacity 1 mAh/cm²) or a short circuit occurred at the start (@ current density 100 mA/cm², cycle capacity 1 mAh/cm²).

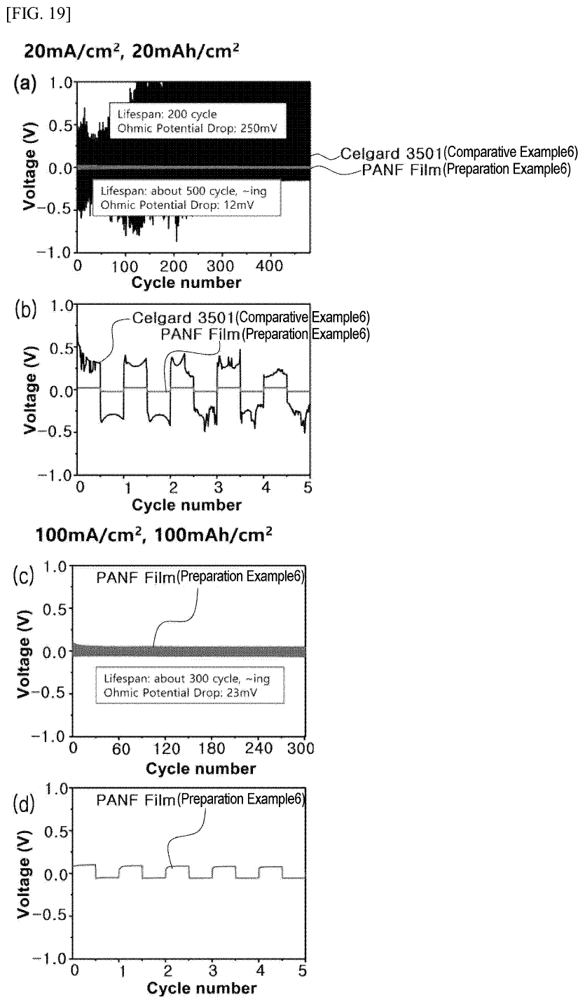

FIG. 19 shows graphs indicating the constant current cycling test results for the Li/Li symmetric cell according to Preparation Example 6 including the PANF prepared in Preparation Example 1 and the Li/Li symmetric cell according to Comparative Example 6 including a polypropylene film (Celgard 3501) of Comparative Example 3 at a current density of 20 mA/cm² and a cycle capacity of 20 mAh/cm² (a, b) and at a current density of 100 mA/cm² and a cycle capacity of 100 mAh/cm² (c, d). The charging or discharging time was fixed at 1 hour.

Referring to FIG. 19, in the case of a cell having the PANF, the cycle proceeds very stably even at 500 cycles or 300 cycles or more even if the current density is increased to 20-100 mA/cm² and the cycle capacity is increased to 20-100 mAh/cm². However, in the case of a cell having Celgard 3501, a short circuit occurred at 200 cycles (@ current density 20 mA/cm², cycle capacity 20 mAh/cm²) or a short circuit occurred at the start (@ current density 100 mA/cm², cycle capacity 100 mAh/cm²).

Therefore, it can be seen that the secondary battery including the PANF according to the present invention has a low resistance, a very low voltage during charging and discharging, and excellent cycle stability, thereby showing stable characteristics even during rapid charging and discharging.

(3) Li Electrode Surface Analysis of a Li/Li Symmetrical Cell Including a Separator

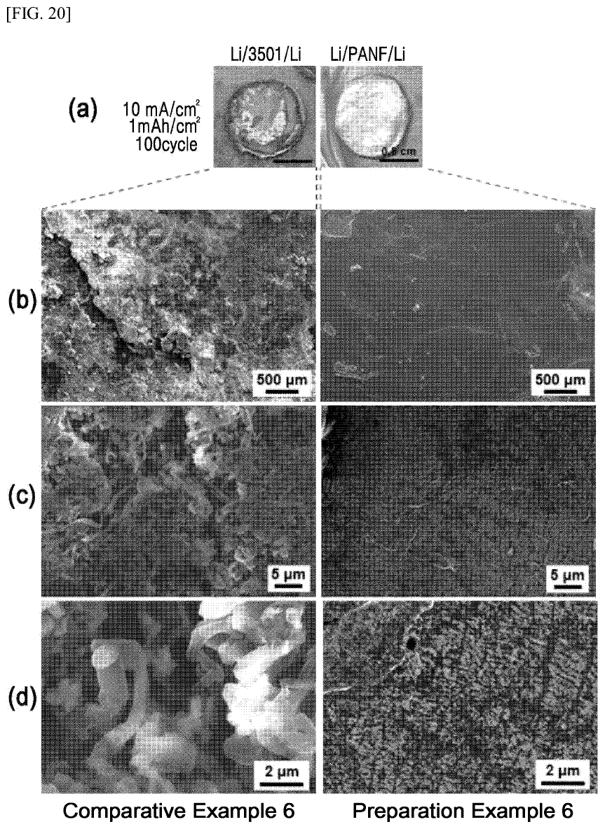

After the Li/Li symmetric cell according to Preparation Example 6 including the PANF prepared in Preparation Example 1 and the Li/Li symmetric cell according to Comparative Example 6 including the polypropylene film (Celgard 3501) of Comparative Example 3 were subjected to constant current cycling test for 100 cycles at a current density of 10 mA/cm² and a cycle capacity of 1 mAh/cm², the surfaces of the Li electrodes were observed and shown in FIG. 20.

FIG. 20 shows photographs (a) and FE-SEM images (b, c, d) showing the surfaces of Li electrodes after a cycling test of Li/Li symmetric cells according to Preparation Example 6 and Comparative Example 6 including separators according to Preparation Example 1 and Comparative Example 3, respectively.

As shown in FIG. 20, the surface of the Li electrode subjected to the cell test with the Celgard 3501 separator became black, and as a result of observation at high magnification through the field emission scanning electron microscope, it was confirmed that lithium dendrites were formed on the surface of the Li electrode.

However, in the case of the cell using the PANF according to the present invention as a separator, the surface of the Li electrode after 100 cycles of constant current cycling test maintained the same color as the initial Li electrode before cycling, and as a result of observation at high magnification through the field emission scanning electron microscopy, it was confirmed that the lithium dendrite formation was suppressed on the surface of the Li electrode and a smooth surface was maintained.

### Preparation of Secondary Battery: Preparation Example 11 and Comparative Example 7

### Production Example 11

First, a lithium iron phosphate (LFP) positive electrode was prepared. Specifically, LiFePO₄ (Xintai Yinhe New Energy Materials Co. Ltd.), carbon black (Super P, TIMCAL), single-wall CNT (CNT, eDIPS EC2.0, MeijoNano Carbon) and PVDF binder (KF polymer W #7300, KUREHA CORPORATION) was mixed with N-methyl-2-pyrrolidone (Daejung Chemical) in a weight ratio of 8:0.7:0.3:1. The resulting black slurry was stirred at 80° C. for 24 hours, then coated on carbon-coated aluminum foil through bar coating, and vacuum dried at 120° C. for 24 hours. Here, the amount of LFP loading was controlled to 1.5 to 2 mgcm⁻².

After that, a lithium secondary battery using the porous aramid nanofiber film prepared according to Preparation Example 1 as a separator was prepared in the same manner as in Preparation Example 6, except that the LFP positive electrode obtained above was used instead of using lithium foil as a positive electrode to assemble a CR2032 coin cell.

### Comparative Example 7

A lithium secondary battery was prepared in the same manner as in Preparation Example 11, except that a commercially available polypropylene membrane (Celgard 3501) of Comparative Example 3 was used as a separator instead of the porous aramid nanofiber film.

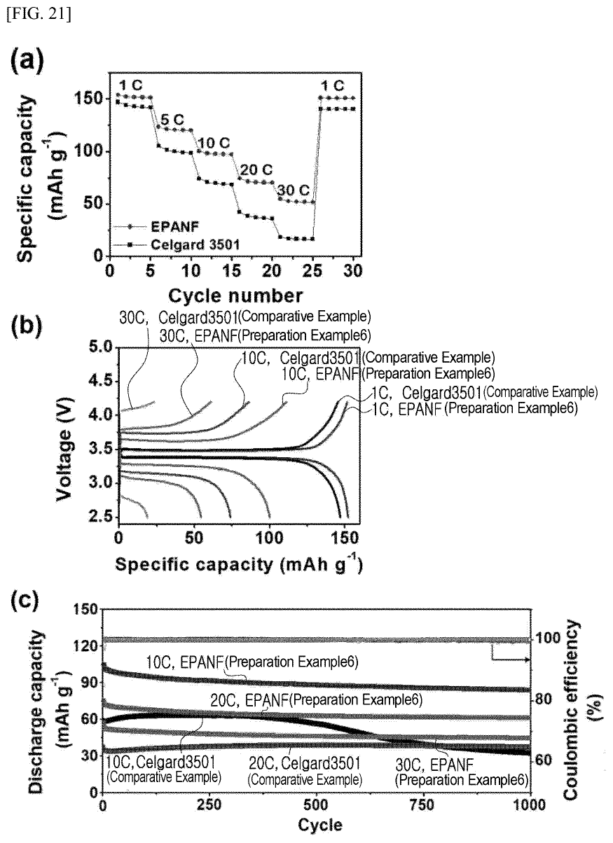

FIG. 21 shows cycle test results at 1 C, 5 C, 10 C, 20 C, and 30 C (a), charge and discharge curves at 1 C, 10 C, and 30 C (b), and cycle performance and coulombic efficiency at 1 C, 10 C, and 30 C (c) of lithium secondary batteries according to Preparation Example 11 and Comparative Example 7. Here, the voltage window was 2.5 to 4.2 V.

Referring to FIG. 21, the lithium secondary battery according to Preparation Example 11 showed a higher capacity retention rate at each C-rate as a result of using the porous aramid nanofiber film of Preparation Example 1 as a separator. In particular, it shows a high specific capacity of 54.7 mAhg⁻¹ even at 30 C, which corresponds to 35.9% of the initial specific capacity (@ 1 C) of 153.7 mAhg⁻¹. On the other hand, in the case of Comparative Example 7 using a commercially available polypropylene membrane (Celgard 3501) as a separator, the specific capacity was 18.7 mAhg⁻¹ at 30 C, which was only 12.7% compared to the initial specific capacity (@ 1 C) of 147.1 mAhg⁻¹ (a).

In the charge/discharge curve (b), the lithium secondary battery according to Preparation Example 11 shows a lower charge/discharge plateau voltage difference compared to Comparative Example 7 at all C-rates.

In addition, in the cycling test (c) up to 1000 cycles, the lithium secondary battery according to Preparation Example 11 showed a capacity retention of 83.2% (84 mAhg⁻¹ compared to 101 mAhg⁻¹) at 10 C, and showed excellent cycling performance compared with the lithium secondary battery according to Comparative Example 7 showing a capacity retention of 55.2% (32 mAhg⁻¹ compared to 58 mAhg⁻¹). Similarly, the lithium secondary battery according to Preparation Example 11 showed relatively high capacity retention of 84.5% and 86.3% at 20 and 30 C after 1000 cycles, respectively. On the other hand, Comparative Example 7 immediately failed in the cycling test at 30 C and no graph was obtained. Coulombic efficiency was ˜100% for most of the cycling tests. These results show that when the porous aramid nanofiber film of Preparation Example 1 is used as a separator, high capacity is maintained even after 1000 cycles at a high rate of more than 10 C.

As described above, according to the present invention, when preparing an aramid nanofiber hydrogel, two-step solvent exchange, in which the aramid nanoseed suspension layer is immersed in an alcohol-containing protic solution in the first solvent exchange step and thereafter immersed in distilled water in the second solvent exchange step, is performed to form a pore structure in which nano-micro sizes are mixed in the aramid nanofiber film. Accordingly, the aramid nanofiber film prepared by the manufacturing method according to the present invention has stable electrical properties, high thermal stability, and low resistance (high ionic conductivity) due to the nano-micro sized pore structure, thereby suppressing the formation of lithium dendrites generated in the solid-electrolyte-interface layer of the negative electrode and increasing the lifespan and safety of the battery; and therefore, it can be usefully used as a separator of a secondary battery.

While the exemplary embodiments of the present invention have been described above, those of ordinary skill in the art should understood that various changes, substitutions and alterations may be made herein without departing from the spirit and scope of the present invention as defined by the following claims.

1. Method for producing a porous aramid nanofiber film comprising:
applying an aramid nanoseed suspension on a substrate to form an aramid nanoseed suspension layer;
immersing the aramid nanoseed suspension layer in an alcohol-containing protic solvent to perform a first solvent exchange to form an aramid nanofiber film by self-assembly;
immersing the first solvent-exchanged aramid nanofiber film in water to perform a second solvent exchange to form an aramid nanofiber hydrogel film; and
freeze-drying the aramid nanofiber hydrogel film to prepare a porous aramid nanofiber film.

2. The method of claim 1, wherein the aramid nanoseed suspension is prepared by stirring aramid fibers in an organic solvent containing a base.

3. The method of claim 2, wherein the organic solvent is N-methyl-2-pyrrolidone, dimethylformamide, dimethyl sulfide, dimethylacetamide, dimethyl sulfoxide, or a mixture thereof.

4. The method of claim 2, wherein the base is an alkali metal hydroxide strong base.

5. The method of claim 2, wherein the aramid fibers have a ratio of 1 to 20 parts by weight based on 100 parts by weight of the organic solvent.

6. The method of claim 1, wherein the application is performed using a method selected from the group consisting of spin coating, blade coating, bar coating, dip coating, gravure coating, spray coating, roll coating and die coating.

7. The method of claim 1, wherein the alcohol-containing protic solvent is a solvent containing only alcohol or a mixed solvent of alcohol and water.

8. The method of claim 1, wherein the alcohol-containing protic solvent has a higher pKa than water.

9. The method of claim 8, wherein the alcohol is ethanol.

10. The method of claim 1, wherein the aramid nanofiber film includes at least one nanopore and at least one micropore.

11. The method of claim 1, wherein the aramid nanofiber film has a thickness of 30 to 100 μm.

12. A porous aramid nanofiber film comprising:
micro-sized micropores and
an aramid nanofiber network which is a region defined by the micro-sized micropores,
wherein nano-sized nanopores positioned within the aramid nanofiber network.

13. The porous aramid nanofiber film of claim 12, wherein the micropores have an average diameter of 1 to 30 μm, and the nanopores have an average diameter of 1 to 100 nm.

14. The porous aramid nanofiber film of claim 13, wherein the micropores have an average diameter of 2 to 25 μm, and the nanopores have an average diameter of 1 to 20 nm.

15. The porous aramid nanofiber film of claim 12, wherein the film has a porosity of 80 to 99%.

16. (canceled)

17. A secondary battery comprising:
a positive electrode;
a negative electrode; and
a porous aramid nanofiber film according to claim 12 interposed between the positive electrode and the negative electrode as a separator.

18. The secondary battery of claim 17, wherein the secondary battery is a lithium secondary battery.

19. The secondary battery of claim 17, wherein the negative electrode is a lithium metal electrode.

20. The secondary battery of claim 17, wherein the porous aramid nanofiber film has a thickness of 5 to 30 μm.
